(19) United States
(12) Patent Application Publication
(10) Pub. No.: US 2017/0279880 A1
(43) Pub. Date: Sep. 28, 2017

(54) PEER CORRESPONDING TO THE DOMAIN IN MULTI-DOMAIN ENVIRONMENT AND METHOD FOR CONTROLLING THE SAME

(71) Applicant: FOUNDATION OF SOONGSIL UNIVERSITY INDUSTRY COOPERATION, Seoul (KR)

(72) Inventors: Young Han KIM, Seoul (KR); Vu anh Vu, Seoul (KR); Hyun Sik YANG, Seoul (KR)

(73) Assignee: FOUNDATION OF SOONGSIL UNIVERSITY INDUSTRY COOPERATION, Seoul (KR)

(21) Appl. No.: 15/169,387

(22) Filed: May 31, 2016

(30) Foreign Application Priority Data
Mar. 24, 2016 (KR) 10-2016-0035520

(51) Int. Cl. H04L 29/08; H04L 29/06; H04L 12/46

(52) U.S. Cl. CPC H04L 67/104; H04L 12/4641; H04L 65/102

(57) ABSTRACT

A peer corresponding to a domain in a multi-domain environment and a method for controlling the peer are provided. The peer includes a Peer Connector for a communications connection with at least one different peer, and a Shared Manager storing information of the peer and information of the at least one different peer received through the peer connector. Also the peer includes a SFC Distributor generating service function chaining (SFC) by using the information of the at least one different peer and the information of the peer.

### CROSS-REFERENCE TO RELATED APPLICATION(S)

This application claims benefit of priority to Korean Patent Application No. 10-2016-0035520 filed on Mar. 24, 2016 in the Korean Intellectual Property Office, the disclosure of which is incorporated herein by reference in its entirety.

### BACKGROUND

1. Field

The present invention relates to a peer generating and managing SFC (Service Function Chaining) in a multi-domain environment and a method for controlling the same.

2. Description of Related Art

Network Functions Virtualization (NFV) systems are technologies for controlling and managing virtual network functions in software. In particular, a service function chaining technology performs a connection and execution operations by sequencing the virtual network functions. Attention to the SFC technology, the next issue of the research into NFV, is being increased in that it allows for customization and automation of key network services. The SFC technology is being developed under the model name of the development of VNF forwarding graph in ETSI NFV ISG, and a standardization progress for the detailed function structure and protocols therefore is being made in the IETF SFC WG.

On the other hand, with an increase in the size of the NFV systems, service providers have to think of measures for providing the service through the structure of a multi-domain form. Conducting a centralized management in the form of geographically distributed environment so as to provide a high quality of service in a multi-domain environment can be an effective management method. Therefore, there is a need for techniques to manage and organize the service function chaining in a multi-domain environment.

### SUMMARY

An aspect of the present invention is to provide a peer generating and managing service function chaining in a multi-domain environment and a method of controlling the same.

According to an aspect of the present invention, a peer corresponding to a domain in a multi-domain environment may include a Peer Connector for a communications connection with at least one different peer; a Shared Manager storing information of the at least one different peer received through the Peer Connector and information of the peer; and a service function chaining (SFC) Distributor generating SFC by using the information of the at least one different peer and the information of the peer.

The information of the at least one of the other peers may include a service function/a service function chaining information generated from the at least one of the other peers, and a resource information of the at least one of the other peers, and the information of the peer may include a service function/a service function chaining information generated from the peer in advance, and a resource information of the peer.

When at least a portion of the service function chaining information to be generated is included in the at least one of the other peers, the Peer Connector may receive at least a portion of the service function/the service function chaining information from one or more the one other of the peers which include the at least a portion of the service function/the service function chaining information of the at least one of the other peers, and the SFC Distributor may generate the service function chaining information by using the at least a portion of the service function/the service function chaining information received.

A service function A/a service function chaining A of the at least a portion of the service function/the service function chaining may be generated from the other peer of the one or more the other peers under control of the peer.

A process of generating the service function chaining of the SFC Distributor by using the at least a portion of the service function/the service function chaining information received may be performed when a value corresponding to the resource information of the peer is less than or equal to a preset resource value.

The domain may be a NFV (Network Function Virtualization), the resource information may include a VNF (Virtual Network Function) information usable at configuration of the service chaining, and a resource to generate a new VNF (Virtual Network Function).

According to an aspect of the present invention, a method of controlling a peer corresponding to a domain in a multi-domain environment may include a peer connector, a shared manager, and a SFC Distributor, the method including receiving information of a peer and information of at least one different peer through the peer connector; storing, by the shared manager, the information of the at least one different peer and the information of the peer; and generating, by the SFC Distributor, a service function chaining (SFC) by using the information of the at least one different peer and the information of the peer.

### BRIEF DESCRIPTION OF DRAWINGS

The above and other aspects, features, and advantages of the subject matter disclosed herein will be described with reference to exemplary embodiments illustrated in the figures, in which:

FIG. 1 is a diagram illustrating a schematic configuration of an NFV system in a multi-domain environment according to an embodiment of the present invention;

FIG. 2 is a diagram illustrating a schematic configuration of a peer interaction gateway according to an embodiment of the present invention;

FIG. 3 is a diagram illustrating a procedure for forming a service function chaining in forms of distribution according to an embodiment of the present invention;

FIG. 4 is a diagram illustrating an information update procedure for a shared resource according to an embodiment of the present invention;

FIG. 5 is a message structure in updating through a JSON (JavaScript Object Notation) template according to an embodiment of the present invention; and

FIG. 6 is a flowchart illustrating a method of controlling a peer according to an embodiment of the present invention.

### DETAILED DESCRIPTION

The singular forms “a”, “an” and “the” used in the context of describing the present invention are intended to include the plural forms as well, unless otherwise noted. The terms “comprising”, “having”, “including”, and “containing” are to be construed as open-ended terms (i.e., meaning “including, but not limited to,”) unless otherwise noted, and therefore, the terms do not preclude the presence or addition of one or more other elements, components, steps, and/or groups thereof. Also, the term “part” or “module”, as used herein, means a unit that processes at least one function or operation, which can be implemented in hardware or software, or implemented as a combination of hardware and software.

Hereinafter, various embodiments of the present invention will be described with reference to the accompanying drawings.

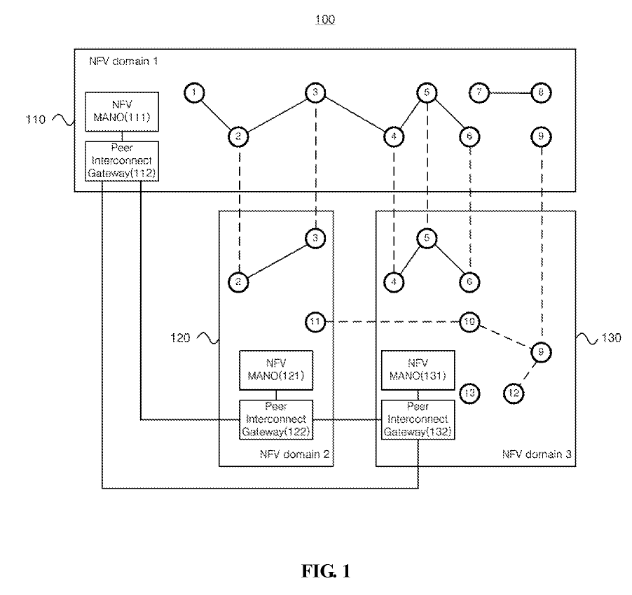

FIG. 1 is a diagram illustrating a schematic configuration of an NFV system in a multi-domain environment according to an embodiment of the present invention.

Referring to FIG. 1, a NFV (Network Functions Virtualization) system may include a plurality of peers 110, 120, and 130. In one embodiment, each of the plurality of peers 110, 120, and 130 may correspond to one NFV domain in a multi-domain environment.

In one embodiment, each of the plurality of peers 110, 120, and 130 may generate a service function or service function chaining (SFC). Here, the service function chaining generated from one peer may include a service function or service function chaining generated by a different peer.

In one example, a first peer 110 may generate a first service function chaining comprised of six service functions (Service Functions 1 to 6). A second peer 120 may generate a second service function chaining comprised of two service functions (Service Functions 2 and 3). And a third peer 130 may generate a third service function chaining comprised of three service functions (Service Functions 4 to 6). In this case, the first service function chaining includes the second service function chaining and the third service function chaining.

In other words, the service function chaining generated from the respective peers 110, 120, and 130 may provide service function chaining independent with respect to the domain, be located in an NFV domain, and managed.

The peers 110, 120, and 130 are connected to each other, and may share peer information (for example, the resource-related information) for service function chaining.

For this, the peers 110, 120, and 130 include NFV MANOs (Management and Orchestration) 111, 121, and 131, and peer interaction gateways (Peer Interconnect Gateway) 112, 122, and 132, respectively. Here, since the peers 110, 120, and 130 have the same configuration, hereinafter, a peer configuration will be described based on the first peer 110 among the peers 110, 120, and 130.

The NFV MANO 111 serves as the control unit for managing the NFV domain, and generates a virtualized network function and service function chaining. Here, the NFV domain provides the service function chaining in a hierarchical form. The NFV domains that correspond to all of the peers 110, 120, and 130 share the same VNF (Virtual Network Function) description template.

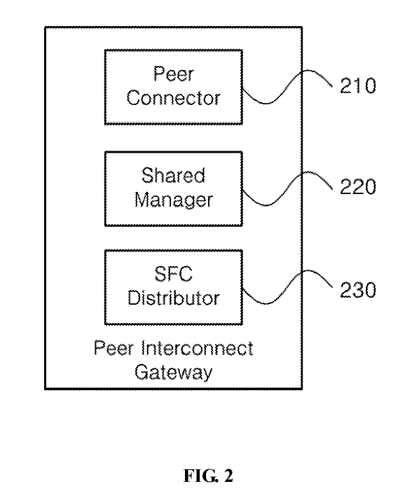

The Peer interaction gateway 112 is a component to connect the peer 110 to other peers 120 and 130 and generate the service function chaining. FIG. 2 is a diagram illustrating a schematic configuration of the peer interaction gateway 112.

Referring to FIG. 2, the peer interaction gateway 112 includes a Peer Connector 210, a Shared Manager 220, and a SFC Distributor 230.

The Peer Connector 210 performs a communications operation for connecting the peer 110 to other peers 120 and 130. To this end, the Peer Connector 210 has information (IP address, physical address, etc) regarding NFV domains corresponding to the peers 120 and 130. The Peer Connector 210 may find locations of the NFV domains through the information. In addition, the Peer Connector 210 is configured in the form of a client with a RESTful sever, and manages messages among the peers.

The Shared Manager 220 stores and manages the information of the peers 120 and 130 received through the Peer Connector 210 and the information of the first peer 110.

In this case, the information of the peers 120 and 130 includes information regarding service function/service function chaining generated from the peers 120 and 130 and resource information of the peers 120 and 130. In a manner similar thereto, the information of the first peer 110 includes information regarding service function/service function chaining generated by the first peer 110 in advance and resource information of the first peer 110. For example, the resource information may include VNF (Virtual Network Function) information usable in the configuration of the service chaining and a resource to generate a new VNF (Virtual Network Function).

The SFC Distributor 230 generates service function chaining by using the information of the peers 120 and 130 and the information of the first peer 110. In other words, the SFC Distributor 230 obtains information of a shaped peer and generates service function chaining suitable therefor through the information of the peer and parameters defined by other peers.

In this case, according to an embodiment of the present invention, for example, when at least a portion of service function chaining to be generated by the first peer 110 is included in other peers 120 and 130, the Peer Connector 210 of the first peer 110 receives the at least a portion of the service function/the service function chaining from one or more peers containing at least a portion of the service function/the service function chaining among the peers 120 and 130. In this case, the SFC Distributor 230 of the first peer 110 may generate service function chaining by using the received at least a portion of the service function/the service function chaining.

As one example, as shown in FIG. 1, in a state in which a second service function chaining comprised of service functions 2 and 3 has been generated in the second peer 120, and a third service function chaining comprised of service functions 4 to 6 has been generated in the third peer 130, a case in which a first service function chaining comprised of service functions 1 to 6 is to be generated in the first peer 110 may occur. In this case, the Peer Connector 210 of the first peer 110 receives the second service function chaining from the second peer 120 and the third service function chaining from the third peer 130, and the SFC Distributor 230 of the first peer 110 only generates the service function 1. Therefore, the SFC Distributor 230 of the first peer 110 may generate the first service function chaining using the generated service function 1 and the received second service function chaining and the received third service function chaining.

In this case, the process of generating the service function chaining by the SFC Distributor 230 using the received at least a portion, in detail, the received service function/service function chaining, may be performed when a value based on the resource information of the first peer 110 is equal to or less than a preset resource value. Here, the preset resource value may be set differently according to the state of the first peer 110.

In other words, for example, when the resource information of the first peer 110 is insufficient and the service function chaining constituting a portion of the first service function chaining is generated in advance in the second peer 120 and the third peer 130, the Peer Connector 210 of the first peer 110 may receive the at least a portion of service function/service function chaining (the second service function chaining and the third service function chaining). And the SFC Distributor 230 may generate the first service function chaining using the received at least a portion of service function/service function chaining (the second service function chaining and the third service function chaining).

On the other hand, the first service function chaining may also be generated in the first peer 110 using a resource in other peers 120 and 130 through shared resource information.

In an example, referring to FIG. 1, in a case in which the third service function chaining comprised of service functions 4 to 6 has been generated in the third peer 130 and any service function chaining is not generated in the second peer 120, a case in which the first peer 110 is to generate a first service function chaining comprised of service functions 1 to 6 may occur. In this case, under control of the first peer 110, the second peer 120 may generate the second service function chaining. And the Peer Connector 210 of the first peer 110 may receive the second service function chaining from the second peer 120 and the third service function chaining from the third peer 130. Accordingly, the first service function chaining may be generated using the received second service function chaining and the received third service function chaining. This operation may also be performed when the value based on the resource information of the first peer 110 is less than or equal to a preset resource value.

In summary, a service function A/a service function chaining A (the second service function chaining) in at least portions of the service function/the service function chaining (the second service function chaining and the third service function chaining) forming the first service function chaining may be generated in a peer A (the second peer 120) among one or more other peers 120 and 130, under control of the first peer 110.

Through this structure, in case that the service function chaining is formed in a multi-domain, efficient services may be provided through re-use of the service function chaining and a connection between domains.

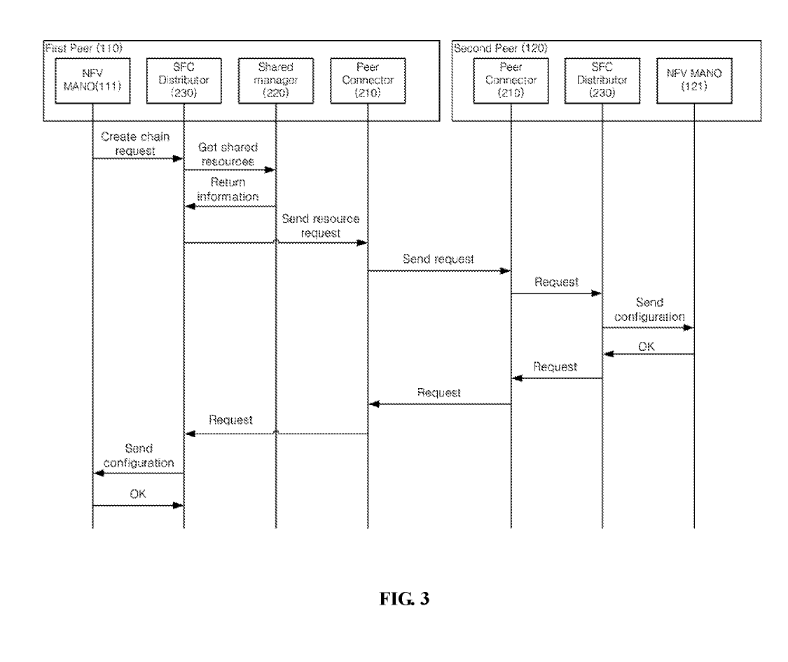

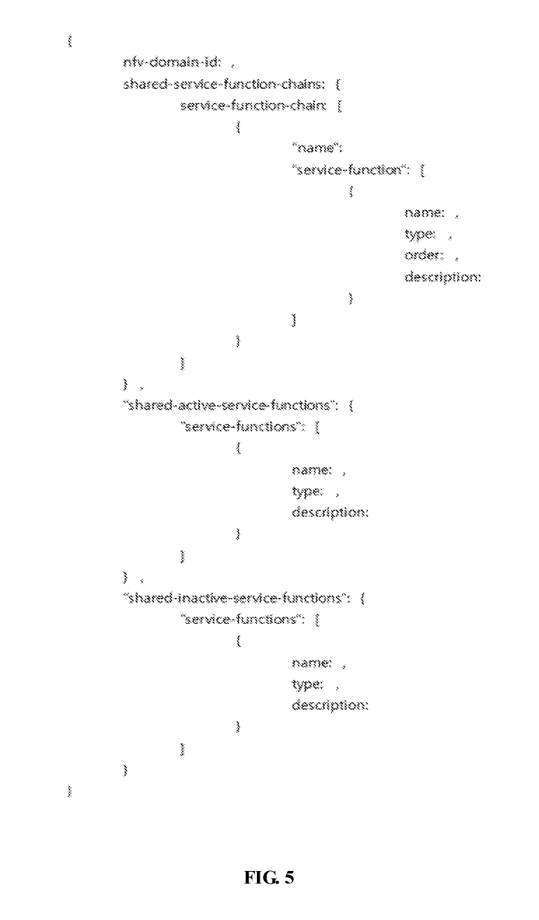

Hereinafter, operations of the peers will be described in detail with reference to FIGS. 3 and 5.

FIG. 3 is a diagram illustrating a procedure for forming service function chaining in forms of distribution according to an embodiment of the present invention.

The SFC Distributor 230 of the first peer 110 may receive a request from the NFV MANO 111, and may configure optimized service function chaining using an algorithm based on the shared resource information received from the Shared Manager 220.

Thereafter, the first peer 110 transmits setting information relevant to a configuration environment over the Peer Connector 210. In other words, the Peer Connector 210 of the first peer 110 sends a request message to the second peer 120 requiring the information via a RESTFul API.

The SFC Distributor 230 of the second peer 120 receives the request message and sends the information to the NFV MANO 121 of the second peer 120, after authenticating the request message. The request message includes information such as generations, updates, or settings with respect to the service function chaining. Also, the request message may include information for path, information of VM generation which is NFVM related settings, or information for path generation.

Upon receiving the information, the NFV MANO 121 of the second peer 120 transmits a confirmation message to the SFC Distributor 230 of the second peer 120. A response message is transmitted to the SFC Distributor 230 of the first peer 110 through the Peer Connector 210 of the second peer 120. The SFC Distributor 230 of the first peer 110 transmits the setting information to the NFV MANO 111 of the first peer 110, and the first peer 110 which finally receives the message completes the setting on the domain.

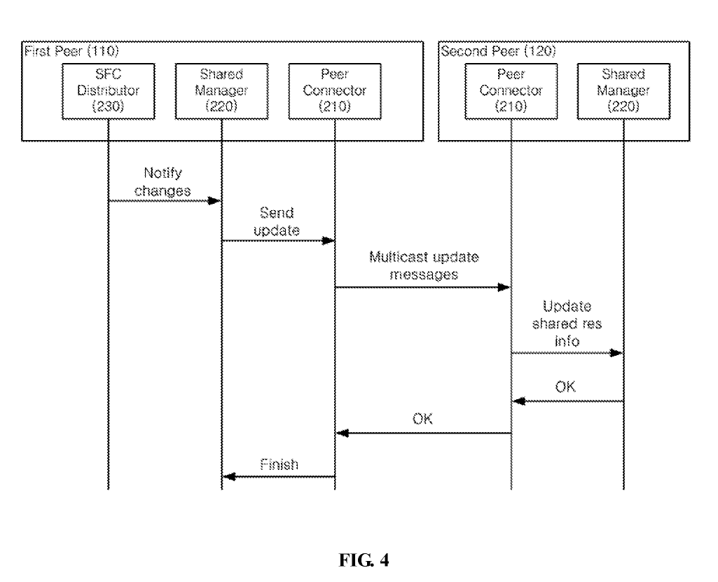

FIG. 4 is a diagram illustrating an information update procedure for a shaped resource according to an embodiment of the present invention.

Referring to FIG. 4, the SFC Distributor 230 of the first peer 110 receives information from the Shared Manager 220, and manages the NFV domain. The Shared Manager 220 transmits the update message for peer information to the Peer Connector 210 of the first peer 110, and then sends the request for the update to the Peer Connector 210 of the second peer 120 in a multicast form.

FIG. 5 is a message structure in updating through a JSON (JavaScript Object Notation) template according to an embodiment of the present invention. In the case that the peer receives the update request message, the peer responds to the request message by adding the updated peer information.

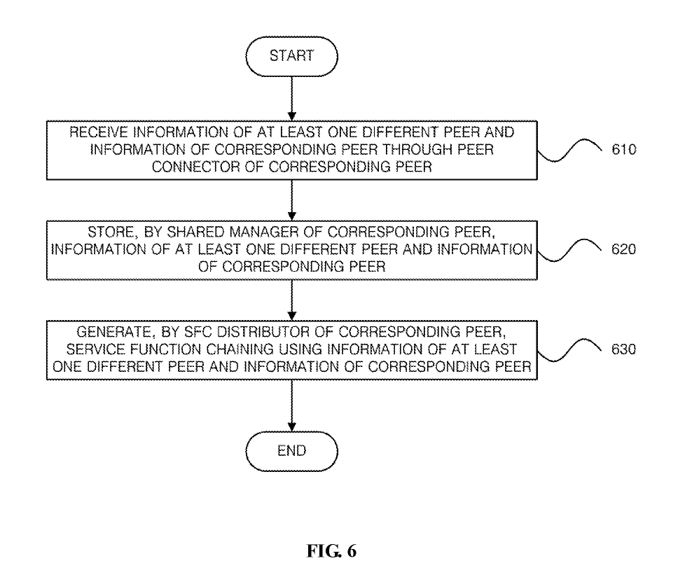

FIG. 6 is a flowchart illustrating a method of controlling a peer according to an embodiment of the present invention.

The method of controlling a peer may be performed in the peer illustrated in FIG. 1 and FIG. 2. Hereinafter, the process performed by each step will be described.

First, in 610, information of a peer (a corresponding peer) and information of at least one different peer are received through a Peer Connector of the peer.

Next, in 620, a Shared Manager of the corresponding peer stores the received information of the at least one different peer and the received information of the corresponding peer.

Subsequently, in 630, a SFC Distributor of the corresponding peer generates service function chaining using the information of the at least one different peer and the information of the corresponding peer.

In this case, the information of the at least one different peer may include information regarding a service function/service function chaining generated from the at least one different peer, and resource information of the at least one different peer. The information of the corresponding peer may include information regarding a service function/service function chaining generated from the corresponding peer in advance, and resource information of the corresponding peer.

Further, for example, when at least a portion of the service function chaining to be generated is included in the at least one or more different peers, in 630, at least a portion of the service function/the service function chaining may be received from the one or more different peers including the at least a portion of the service function/the service function chaining among the at least one or more different peers, through the Peer Connector of the corresponding peer. Thus, the service function chaining may be generated using the received at least a portion of the service function/the service function information.

On the other hand, although not illustrated in FIG. 6, prior to operation 630, an operation of transmitting a command message for generating a service function A/a service function chaining A of the at least a portion of the service function/the service function chaining to a peer A of the one or more different peers may be further included. In this case, the peer A may generate the service function A/the service function chaining A on the basis of the command message.

So far it has been described with respect to examples of the method of controlling a peer according to embodiments of the invention, and the configuration of the first peer 110 described in FIG. 1 to FIG. 5 described above may be applied to the method. Therefore, a more detailed description will be omitted.

In addition, the technical contents described above may be recorded on computer readable media by implementing in a program instruction form that may be executed by various computer means. The computer readable media may also include, program instructions, data files, data structures, and the like alone or in combination with each other. The program instructions recorded on the computer readable media may be specifically designed and configured to implement embodiments, or may be available by the ones skilled in the computer software art. Examples of the computer readable recording media may include magnetic media such as hard disks, floppy disks, and magnetic tapes, optical media such as CD-ROMs and DVDs, magneto-optical media such as a floptical disk, and hardware devices such as ROM (ROM), random access memory (RAM), and a flash memory. The hardware devices may be specially configured to store and perform program instructions. Examples of program instructions include not only a machine code such as produced by a compiler but also a higher level code that may be executed by the computer using an interpreter. The hardware devices may be configured to act as one or more software modules in order to perform the operations in the embodiments, or vice versa.

While the present invention as described above has been described with reference to particular details such as specific components and example embodiments and drawings, which merely provided to assist a thorough understanding of the present invention, the present invention is not limited to the examples described above. It will be apparent to those skilled in the art to which the invention pertains that various changes and modifications may be made thereto the described embodiments. Therefore, it should be understood that the scope of the present invention is not limited to the examples described above. It is, therefore, to be understood that the appended claims are intended to cover all such modifications and changes as fall within the scope of the embodiments.

What is claimed is:

1. A peer corresponding to a domain in a multi-domain environment, the peer comprising:
a Peer Connector for a communications connection with at least one different peer;
a Shared Manager storing information of the at least one different peer received through the Peer Connector and information of the peer; and
a service function chaining (SFC) distributor generating SFC by using the information of the at least one different peer and the information of the peer.

2. The peer of claim 1, wherein the information of the at least one different peer comprises information regarding a service function/a service function chaining generated from the at least one different peer, and resource information of the at least one different peer, and
the information of the peer comprises information regarding a service function/a service function chaining generated from the peer in advance, and resource information of the peer.

3. The peer of claim 2, wherein when at least a portion of the service function chaining to be generated is included in the at least one different peer, the Peer Connector receives the at least a portion of the service function/the service function chaining from one or more different peers including the at least a portion of the service function/the service function chaining of the at least one different peer, and
the SFC Distributor generates the service function chaining by using the at least a portion of the service function/the service function chaining.

4. The peer of claim 3, wherein a service function A/a service function chaining A of the at least a portion of the service function/the service function chaining are generated from a different peer among the one or more different peers under control of the peer.

5. The peer of claim 3, wherein the service function chaining of the SFC Distributor is generated using the at least a portion of the service function/the service function chaining when a value based on the resource information of the peer is equal to or less than a preset resource value.

6. The peer of claim 3, wherein the domain is a network function virtualization (NFV) domain, and the resource information includes virtual network function (VNF) information usable in a configuration of the service function chaining and a resource to generate a new VNF.

7. A method of controlling a peer corresponding to a domain in a multi-domain environment, the peer including a peer connector, a shared manager, and a SFC Distributor, the method comprising:
receiving information of a peer and information of at least one different peer through the peer connector;
storing, by the shared manager, the information of the at least one different peer and the information of the peer; and
generating, by the SFC Distributor, a service function chaining (SFC) by using the information of the at least one different peer and the information of the peer.

8. The method of claim 7, wherein the information of the at least one different peer comprises information regarding a service function/service function chaining generated from the at least one different peer, and resource information of the at least one different peer; and
the information of the peer comprises information regarding a service function/service function chaining generated from the peer in advance, and resource information of the peer.

9. The method of claim 8, wherein when at least a portion of the service function chaining to be generated is included in the at least one different peer, the generating of the service function chaining (SFC) comprises:
receiving at least a portion of the service function/the service function chaining from one or more different peers including the at least a portion of the service function/the service function chaining of the at least one different peer, through the peer connector; and
generating the service function chaining using the received at least a portion of the service function/the service function chaining.

10. The method of claim 9, further comprising transmitting a command message for generating a service function A/a service function chaining A of the at least a portion of the service function/the service function chaining to a peer A among the one or more different peers, prior to the generating of the service function chaining,
wherein the peer A generates the service function A/the service function chaining A on the basis of the command message.
